(19) United States
(12) Patent Application Publication
(10) Pub. No.: US 2009/0113961 A1
(43) Pub. Date: May 7, 2009

(54) Remote Controllable Locking Device for a Vehicle

(76) Inventor: Ulrich Muller, Velbert (DE)

Correspondence Address: FRIEDRICH KUEFFNER, 317 MADISON AVENUE, SUITE 910, NEW YORK, NY, 10017, US

(21) Appl. No.: 11/992,623

(22) PCT Filed: Sep. 27, 2006
(86) PCT No.: PCT/EP2006/009171

§ 371 Date: Mar. 26, 2008

(30) Foreign Application Priority Data
Sep. 27, 2005 (DE) 20 2005 015 165.3

(51) Int. Cl. E05B 65/12

(52) U.S. Cl. 70/256; 340/5.26

(57) ABSTRACT

The invention relates to a remote controlled locking device for vehicles, a stationary lock being located inside the vehicle and a portable electronic key (20) being in the possession of an authorized person. The key (20) comprises a display for actual data of the locking and/or operating states of the vehicle as well as a keypad for calling up this data and/or for controlling the future locking and/or operating states from the vehicle. In order to obtain small dimensions of the key, the invention provides that both the display as well as the keypad (22 to 24) are located at the same location in the key (20) and, to this end, a touch screen (21) is used.

Locking devices for motor vehicles are known in which the locks on the doors, hoods, and hatches of the motor vehicle can already be locked or unlocked from a distance by a so-called “electronic key”. The remote control is accomplished by coded electromagnetic signals between transmitters and receivers in the motor vehicle, on the one hand, and in the key, on the other hand. This can be done monodirectionally or bidirectionally.

DE 41 02 020 A1 discloses a locking device of the type specified in the introductory clause of Claim 1. In this locking device, the key already has a display for displaying current data regarding the locking and/or operating states of the motor vehicle. The communication for the identification of the code goes through a main transmitter in the key and a main receiver in the motor vehicle. However, besides these, there are also an auxiliary transmitter in the motor vehicle and an auxiliary receiver in the key, which acquire the data in the motor vehicle and make it optically readable in a display of the key. Various function keys are provided for this purpose in the key. These function keys interact with a central processing unit provided in the key in order to retrieve the given data that is desired.

To make several data simultaneously readable, the display in the key must be sufficiently large. The number of keys in the keypad of the key also increases with the number of functions that are to be displayed. This is inconsistent with the general goal of designing the electronic key as small as possible, so that it can be easily carried in pant pockets or jacket pockets.

The objective of the invention is to develop a locking device of the type specified in the introductory clause of Claim 1, in which the key has small dimensions despite its varied display possibilities. In accordance with the invention, this objective is achieved by the measures specified in Claim 1, which have the following special significance.

The invention proposes to position both the display and the keypad in the same place in the key. This is possible because a so-called “touch-sensitive display screen” is integrated in the key. The touchscreen allows data to be displayed, and at the same time its screen surface can also be used as a keypad for retrieving data and/or controlling locking and/or operating states in the motor vehicle. A touch-sensitive display screen of this type is also known as a “touchscreen”.

Touchscreens of this type are well known in themselves and are used in cell phones, smart phones, industrial PC's, in information terminals in home entertainment, or in office copiers. Another important area of application of touchscreens is their use in terminals in financial institutions, e.g., for transfers or automatic teller machines. However, it has not been suggested that these well-known touchscreens also be applied to electronic keys and associated locking devices in motor vehicles.

The key of the invention makes it possible, depending on the touch operation of the screen, to read the current operating states of individual motor vehicle parts or other devices integrated in the motor vehicle and, conversely, if necessary, to control them from the key. This can apply to practically all elements and data in the motor vehicle.

Operating states to be displayed and/or controlled could include, besides the locks in the doors, trunk, or hatch of the motor vehicle, an auxiliary heater in the motor vehicle, the air conditioning system of the motor vehicle, the fuel tank level of the motor vehicle, the charge status of the batteries, the current odometer reading, the number of miles the motor vehicle can still be driven with the present fuel tank level, or the like.

In addition, however, general data can also be displayed or requested, such as the present location of the motor vehicle as determined by a navigation system, the temperature inside and/or outside the motor vehicle, the temperature of individual devices in the motor vehicle, the time of day, or the date of the next motor vehicle inspection.

The display screen in the touchscreen of the key also makes it possible, when the motor vehicle is to be started, to offer the motor vehicle operator a numerical keypad to allow him to enter a PIN number to prove his authorization to operate the motor vehicle and/or to retrieve data from the motor vehicle. This occurs on the model of the proof of authorization to use a cell phone.

However, the key can also be part of an alarm system that acts as an alarm signaling device to determine a theft or break-in of the motor vehicle and notify the owner of the key. The electronic key can also be used to provide traffic congestion messages during the use of a motor vehicle navigation system, after the desired driving destination has previously been programmed into the system. In combination with the time display, the electronic key also becomes an alerting system that reminds the owner of the electronic key of appointments, etc.

When the device is not in use, the touchscreen and the associated electronics in the key are shut off or placed in sleep mode to preserve the power source in the key. The touchscreen and the associated electronics can be started up automatically by starting the key. However, they can also be turned on by operating an on/off switch provided on the key. It is advisable to combine the latter method in connection with the aforementioned PIN number.

Finally, to prevent damage to the touchscreen by other objects when the device is being carried in one's pocket, it is advisable to cover the touchscreen when it is not in use. This can be accomplished with a rotating flap, a sliding cover, or a slip cover.

The drawings show a specific embodiment of the invention in various operating modes for various touch operations.

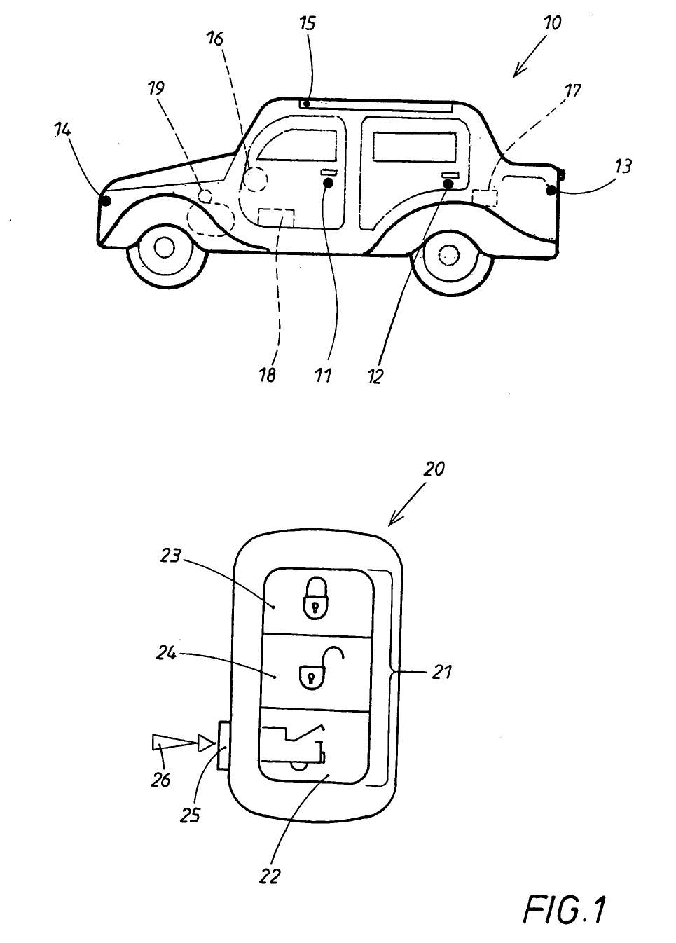

FIG. 1 is a schematic representation of a first phase involving the use of an electronic key that belongs to a motor vehicle and is furnished with a touchscreen.

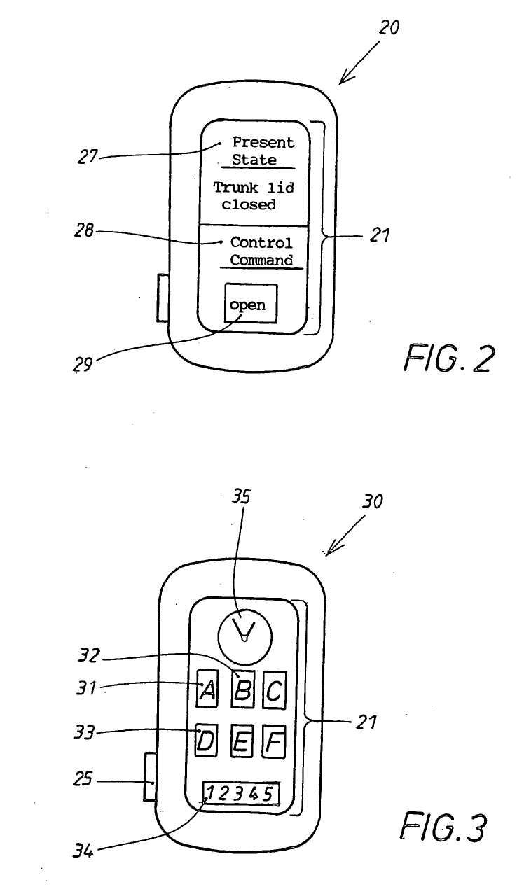

FIG. 2 shows the same key as in FIG. 1 after a first reply from the motor vehicle has appeared on the touchscreen.

FIG. 3 shows the same electronic key for displaying or controlling other functions in or around the motor vehicle.

FIG. 1 shows schematically an electronic key 20 and a motor vehicle 10 with those devices that can remotely communicate with the electronic key 20 and, when necessary, receive commands from the key 20. The key 20 is specially designed for this purpose.

The key 20 contains a touch-sensitive display screen 21, whose visible screen surface simultaneously serves as a keypad, which can be operated in certain fields, e.g., at 22 to 24 in the illustrated embodiment, in order to transmit corresponding control commands to the motor vehicle 10.

The motor vehicle 10 is equipped with various devices, nine examples of which (11 to 19) are shown in FIG. 1. In the embodiment illustrated here, there are locks 11, 12 in the doors and an additional lock 13 for the trunk. There may also be locking devices 14, 15 for the hood or the roof of the motor vehicle. Finally, the motor vehicle 10 has many other devices, including, for example, an odometer 16, an on-board battery 17, an antitheft system 18, and a fuel gauge 19. Naturally, many other instruments and devices could be provided that can be interrogated with respect to the current operating state and, if necessary, remotely controlled from the key 20.

In the present case, the key 20 has an on/off switch 25, which is pressed to activate the key 20. Other possible means of accomplishing this are specified in the claims. In the specific embodiment of FIG. 1, the screen 21 has a mode key 22, which, when actuated, displays a changing sequence of operating modes. In the embodiment illustrated in FIG. 1, the operating readiness of the key with respect to the trunk lid of the motor vehicle 10 is displayed alphanumerically or graphically. At the same time, the current locking state of the trunk lid can be displayed in the other touch operating fields 23 or 24. This can be made known by symbolic representations that are suitably different in brightness and/or color. For example, the reply is received in the display field 24 that the trunk lid is open. The user can then immediately react to this display in the display field 24 by locking the trunk lock 23 or setting in motion a locking mechanism for closing the trunk lid by means of the adjacent touch operating field 23.

FIG. 2 shows a case that is an alternative to FIG. 1 and also involves the trunk lid. In this case, the current state of operation of the part of the motor vehicle previously selected by the user by operation of the display screen 21 is displayed in a field 27, which is possibly larger than the touch operating fields 22-24 shown in FIG. 1. This part of the motor vehicle is again the trunk lid. If the authorized user does not want the state of operation announced in the display field 27, he can operate an appropriately labeled field 29 in the adjacent field of the display screen 21, which now operates as a keypad. This causes the control command “open the trunk lid”, which appears in this field 29, to be transmitted.

FIG. 3 shows the same or an alternative key 30, in which the corresponding touchscreen 21 not only provides a display of the given current conditions in the motor vehicle but also, after a certain mode has been selected, offers various touch fields 31 to 33, with which the given conditions can be changed. This is illustrated in FIG. 3 with graphic symbols A to F. In addition, there is a display field 34, in which, for example, the current odometer reading of the motor vehicle 10 is numerically displayed on the electronic key 30. After a certain prompt time has elapsed, the key 30 can also spontaneously and automatically relay control commands to the motor vehicle 10 to initiate certain desired functions, e.g., to turn on an auxiliary heater in the motor vehicle.

The number of other possibilities has already been explained in the specification.

### LIST OF REFERENCE NUMBERS

10 motor vehicle
11 first door lock
12 second door lock
13 trunk lock of 10
14 locking device for motor vehicle hood
15 locking device for motor vehicle roof
16 first device for 10, odometer
17 second device for 10, on-board battery
18 third device for 10, antitheft system
19 fourth device for 10, fuel gauge
20 first electrical lock
21 touchscreen of 20 or 30
22 display field/touch operating field, mode key
23 display field/touch operating field, function key
24 display field/touch operating field, function key
25 on/off switch on 20 or 30
26 pressure operation of 25
27 first display/touch field (FIG. 2)
28 second display/touch field (FIG. 2)
29 touch operating field of 28 (FIG. 2)
30 electronic key (FIG. 3)
31 first display/touch operating field of 21 (FIG. 3)
32 second display/touch operating field of 21 (FIG. 3)
33 third display/touch operating field of 21 (FIG. 3)
34 numerical display field on 30
35 time display on 30

1. A remote-controllable locking device for a motor vehicle (10) with at least one stationary lock (11 to 13) in the motor vehicle (10) and with a portable electronic key (20, 30) in the possession of an authorized person, where the key (20, 30) has a display for the current data of the locking and/or operating states of the motor vehicle (10) and a keypad for retrieving this data and/or for controlling the future locking and/or operating states of the motor vehicle (10), wherein both the display (22 to 24) and the keypad (22 to 24) are positioned in the same place in the key (20) and are formed by a touchscreen (21).

2. A device in accordance with claim 1, wherein the operating states of individual parts (11 to 15) of the motor vehicle or other devices (16 to 19) integrated in the motor vehicle are displayed and/or controlled as a function of the particular touch operation and touch operation sequence of the display screen (21).

3. A device in accordance with claim 1, wherein, besides the locks (11 to 13) in the doors, trunk, or hatch of the motor vehicle, it is possible to display and/or control an auxiliary heater in the motor vehicle, the air conditioning system of the motor vehicle, the fuel tank level (18) of the motor vehicle, the state of charge of the batteries (17), the current odometer reading (16) and/or the number of miles the motor vehicle can still be driven with the present fuel tank level.

4. A device in accordance with claim 1, wherein navigation data for the present location of the motor vehicle (10), data for optical or acoustic position finding of the motor vehicle, the temperature inside and/or outside the motor vehicle, the temperature of individual devices in the motor vehicle, the present time of day (35), and/or the date of the next motor vehicle inspection can be displayed on the touchscreen (21).

5. A device in accordance with claim 1, wherein during the startup of the display and/or the control function of the electronic key (20 to 30), a code keypad appears on the touchscreen (21) and is used by the authorized person to enter the specific PIN number for the electronic key (20, 30) and for the associated motor vehicle (10), and that the electronic key (20, 30) becomes or remains operationally ready only when the correct PIN number is entered.

6. A device in accordance with claim 1, wherein the electronic key (20, 30) is part of an alarm system (18) of the motor vehicle and acts as an alarm signaling device in the event of a theft or break-in of the motor vehicle.

7. A device in accordance with claim 1, wherein the electronic key (20, 30) serves as an alarm for traffic congestion messages and/or its touchscreen serves to display traffic congestion messages, and that these traffic congestion messages are issued by a navigation system, which is located in the motor vehicle or integrated in the electronic key (20, 30) and into which a desired driving destination has been programmed.

8. A device in accordance with claim 1, wherein, when the device is not in use, the touchscreen (21) and the associated electronics in the key are shut off or placed in power-saving mode to preserve its power supply.

9. A device in accordance with claim 8, wherein the electronic key (20, 20) turns on automatically when it is started.

10. A device in accordance with claim 8, wherein the electronic key is turned on manually by operation (26) of a switch (25) located on the housing of the electronic key.

11. A device in accordance with claim 1, wherein when the electronic key (20, 30) is not being used, the display side of the touchscreen (21) is covered.

12. A device in accordance with claim 11, wherein the cover consists of a rotating flap, a sliding cover, or a slip cover.
